(19) United States
(12) Patent Application Publication
(10) Pub. No.: US 2013/0111741 A1
(43) Pub. Date: May 9, 2013

(54) BAFFLE PLATE DISASSEMBLING INSTRUMENT

(71) Applicants: CHIN-WEN YEH, Tu-Cheng (TW); ZHI-JIAN PENG, Wuhan City (CN); YANG XIAO, Wuhan City (CN); DUN-JUN ZHOU, Wuhan City (CN)

(72) Inventors: CHIN-WEN YEH, Tu-Cheng (TW); ZHI-JIAN PENG, Wuhan City (CN); YANG XIAO, Wuhan City (CN); DUN-JUN ZHOU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/336,048

(22) Filed: Dec. 23, 2011

(30) Foreign Application Priority Data
Nov. 7, 2011 (CN) 201110347956.5

(51) Int. Cl. B23P 19/04

(52) U.S. Cl. 29/764

(57) ABSTRACT

A baffle plate disassembling instrument for an electronic device is disclosed. The baffling plate disassembling instrument for a comprises a handle; a bracket mounted on a top end of the handle; and two engaging members mounted on a top side of the bracket, the two engaging members are configure to be inserted into the baffling plate; wherein a distance between the two engaging members is adjustable according to the baffling plate.

### BACKGROUND

1. Technical Field

The present disclosure relates to instruments, and more particularly to a baffling plate disassembling instrument for disassembling baffle plates from an electronic device.

2. Description of Related Art

Multiple peripheral components interconnect (PCI) cards are mounted on an electronic device to enhance capability of the electronic device. The electronic device, such as a computer box, includes a plurality of baffling plates to baffle PCI card sockets thereof. When the PCI cards need to be mounted on the electronic device, the baffling plates must be removed from the electronic device firstly

Generally, a screw driver is used to disassemble the baffling plates from the electronic device. One end of the screw driver is inserted to a slit of the baffling plate and intimately engages with the baffling plate, and another end of the screw driver is swung to disassemble the baffling plate from the electronic device. Because a contact area of the screw driver and the baffling plate is small, a force applied by the screw driver is concentrated on a small area of the baffling plate. So the screw driver must be swung a plurality of times with a large angle to disassemble the baffling plate from the electronic device. This is a time-consuming and not cost effective. In addition, the screw driver is prone to strike the electronic device when it is swung. Thus, stability of the electronic device is adversely affected.

Accordingly, it is desirable to provide a baffling plate disassembling instrument which can overcome the above described disadvantages.

### BRIEF DESCRIPTION OF THE DRAWINGS

FIG. 1 is an isometric, assembled view of a baffling plate disassembling instrument of the present disclosure.

FIG. 2 is an exploded view of the baffling plate disassembling instrument of FIG. 1.

FIG. 3 is an inverted view of FIG. 2.

FIG. 4 shows the baffling plate disassembling instrument inserted in a baffling plate of an electronic device to disassemble the baffling plate from the electronic device.

### DETAILED DESCRIPTION

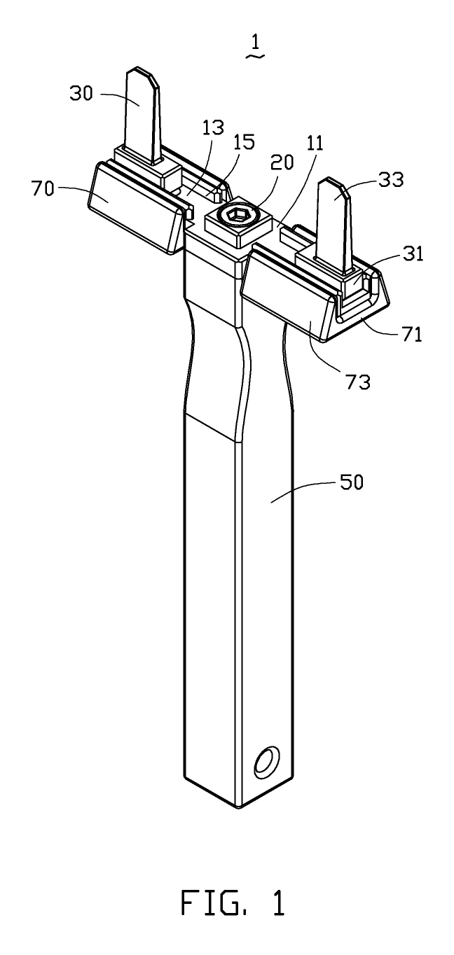

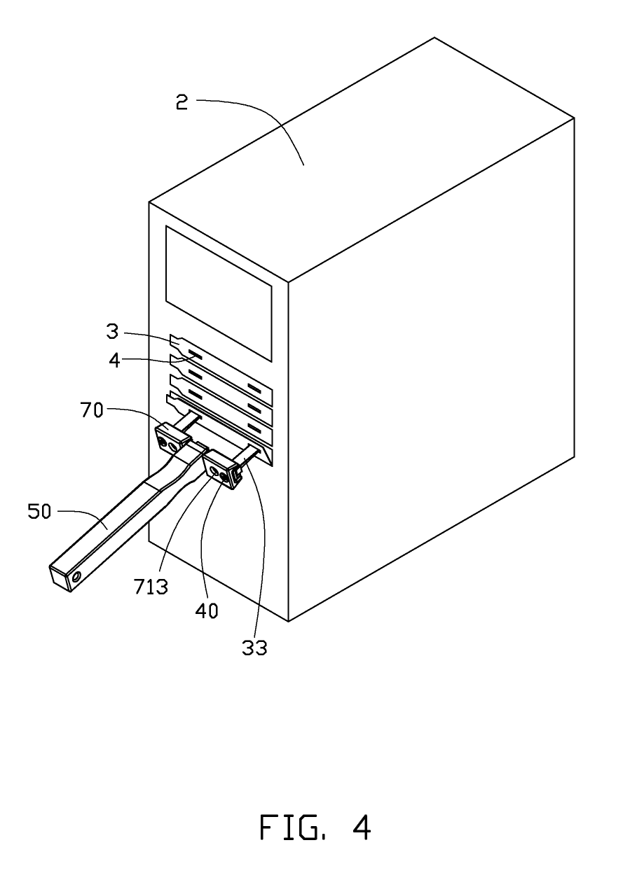

Referring to FIG. 1 and FIG. 4, a baffling plate disassembling instrument 1 for disassembling a plurality of baffling plates 3 from an electronic device 2 is show. The baffling plate disassembling instrument 1 comprises a bracket 10, two engaging members 30 mounted on a top side of the bracket 10, and a handle 50 mounted on a bottom side of the bracket 10.

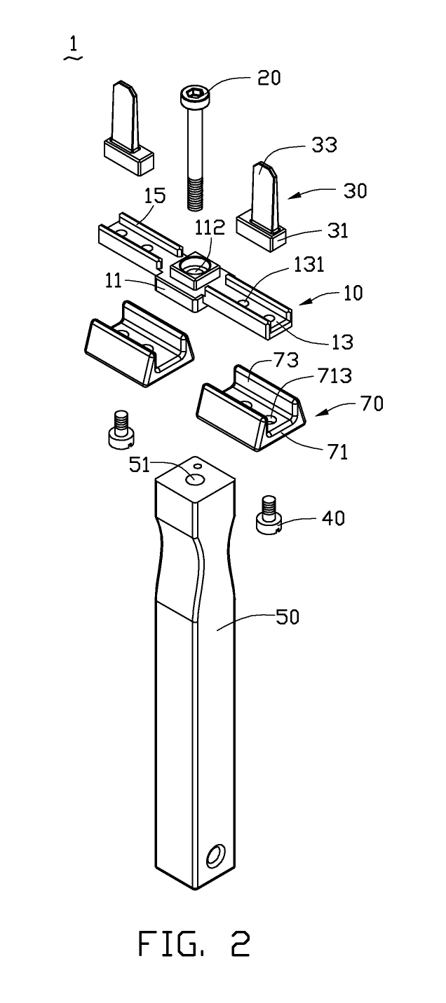

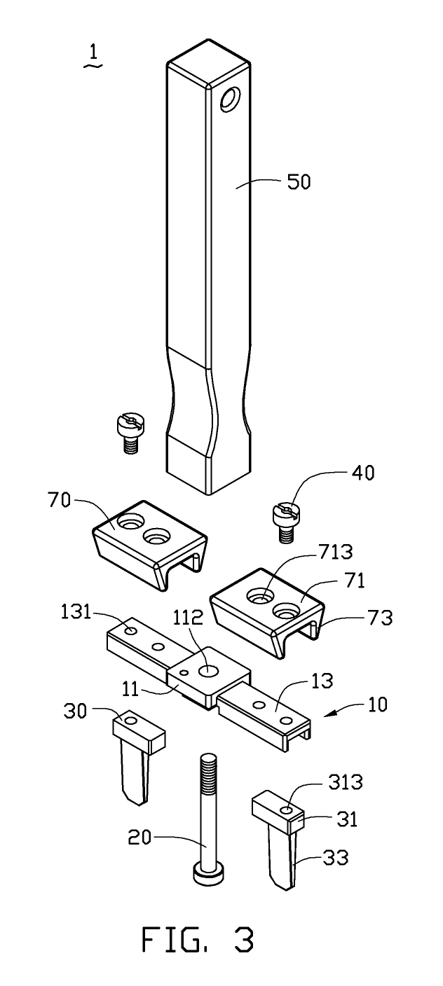

Referring also to FIGS. 2-3, the handle 50 is substantially cubical and a mounting hole 51 is defined at a central portion of a top end thereof. The bracket 10 comprises a mounting portion 11 and two supporting portions 13 located at lateral ends of the mounting portion 11. The mounting portion 11 is rectangular and a size thereof is equal to that of the top end of the handle 50. A through hole 112 is defined at a central portion of the mounting portion 11. A bottom surface of the mounting portion 11 abuts the top end of the handle 50. The through hole 112 is aligned with the mounting hole 51 of the handle 50. A screw 20 extends through the through hole 112 and engages in the mounting hole 51 of the handle 50 to fix the bracket 10 to the handle 50. A thickness of the mounting portion 11 is larger than a thickness of each of the two supporting portions 13 to enhance a strength of the mounting portion 11 and the handle 50.

Each of the two supporting portions 13 is a rectangular plate and perpendicularly connects a central portion of a top end of the lateral end of the mounting portion 11. Two spaced through holes 131 are defined in each of the two supporting portions 13 and aligned with each other. Two flanges 15 perpendicularly extend from opposite sides of each of the two supporting portions 13 to sandwich one of the two engaging members 30 therebetween.

Each of the two engaging members 30 comprises an engaging portion 31 mounted on each of the two supporting portions 13 and a crowbar 33 extending from the engaging portion 31. The engaging portion 31 is cubical and a blind hole 313 is defined in a lateral end of a bottom portion thereof. The crowbar 33 is mounted on a top surface of the engaging portion 31 and located at a top of the blind hole 313. The crowbar 33 is a cuneal plate. A thickness of the crowbar 33 is decreased from a bottom end near the engaging portion 31 to an outer end of the crowbar 33. A length and a width of the bottom end of the crowbar 33 are less than that of the engaging portion 31. The crowbar 33 is located at a central portion of an outer side of the top surface of the engaging portion 31.

When the two engaging members 30 are assembled on the two supporting portions 13, the engaging portions 31 respectively abut against the two supporting portions 13 and are sandwiched between the two flanges 15. Two screws 40 respectively, selectively extend through one of the two through holes 131 of each of the two supporting portions 13 and engage in the blind holes 313 of the engaging portions 31 to assemble the two engaging members 30 on the bracket 10. When the two screws 40 engage in different through holes 131, a distance between two of the crowbars 33 is different. Thus, the distance between two of the two crowbars 33 is adjustable and the baffling plate disassembling instrument 1 can suitable for different types of baffling plates 3. It should be understood that the two through holes 131 defined in each of the two supporting portions 13 can be more than two.

Referring to FIG. 4 again, each baffling plate 3 is defined two of slits 4 therein. The slits 4 are aligned with each other. When the baffling plate 3 needs to be disassembled from the electronic device 2, the crowbar 33 of the baffling plate disassembling instrument 1 are respectively inserted in the slits 4 of the baffling plate 3 until the crowbar 33 intimately engage with the baffling plate 3. The baffling plate disassembling instrument 1 is swung via operating the handle 50. Because a contact area of the baffling plate disassembling instrument 1 and the baffling plate 3 is increased relative to the conventional screw driver, thus, the baffling plate 3 is easy to be disassembled from the electronic device 2.

Furthermore, two elastic bumpers 70 respectively surround the two supporting portions 13 of the bracket 10 therein. Each of the two bumpers 70 comprises a rectangular base plate 71 and two sidewalls 73 slantwise extending from opposite sides of the base plate 71. The base plate 71 is arranged on a bottom surface of each of the two supporting portions 13 and an inner end thereof abuts the mounting portion 11 of the bracket 10. Each of the two sidewalls 73 is arranged on an outer surface of each of the two flanges 15, and intimately abuts against the outer surfaces of the two flanges 15. Two receiving holes 713 are defined in the base plate 71 to receive a part of one of the two screws 40 therein. The two bumpers 70 are used to mitigate impact between the baffling plate disassembling instrument 1 and the electronic device 2.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A baffling plate disassembling instrument for a baffling plate from an electronic device comprising:
a handle;
a bracket mounted on a top end of the handle; and
two engaging members mounted on a top side of the bracket, the two engaging members being configure to be inserted into the baffling plate;
wherein a distance between the two engaging members is adjustable according to the baffling plate.

2. The baffling plate disassembling instrument of claim 1, wherein each of the two engaging members defines a blind hole at a bottom portion therein, the bracket comprises two supporting portions, each of the two supporting portions supports each of the two engaging members, each of the two supporting portions defines two through holes therein, and a screw extends through one of the two through holes of each of the two supporting portions, the two engaging members are assembled to the bracket with the screw engaging in the blind hole of each of the two engaging members.

3. The baffling plate disassembling instrument of claim 2, wherein each of the two engaging members comprises an engaging portion mounted on each of the two supporting members, and a crowbar extending from the engaging portion.

4. The baffling plate disassembling instrument of claim 3, wherein the engaging portion is cubical, and the blind hole is defined in a bottom portion of the engaging portion.

5. The baffling plate disassembling instrument of claim 4, wherein the crowbar is mounted on a top surface of the engaging portion and located at a top of the blind hole.

6. The baffling plate disassembling instrument of claim 4, wherein the crowbar is a cuneal plate and a thickness of the crowbar is decreased from bottom to top of the crowbar.

7. The baffling plate disassembling instrument of claim 2, wherein each of the two supporting portions is an elongated plate, two flanges extending upwardly from opposite sides of each of the two supporting portions and sandwiching one of the two engaging members therebetween.

8. The baffling plate disassembling instrument of claim 7 further comprising two elastic bumpers, each of the two elastic bumpers surrounds each of the two supporting portions of the bracket.

9. The baffling plate disassembling instrument of claim 8, wherein each of the two elastic bumpers comprises a base plate arranged on a bottom surface of the supporting portion, and two sidewalls extending from opposite sides of base and arranged on outer surfaces of each of the two flanges.

10. The baffling plate disassembling instrument of claim 8, wherein two receiving holes are defined in the base plate to receive a part of the screw engaged with the blind hole.

11. The baffling plate disassembling instrument of claim 2, wherein the bracket further comprises a mounting portion located between the two supporting portions and interconnects with the two supporting portions; and the bracket is fixed on to the handle by a screw extending through the mounting portion and engaging with the handle.

12. The baffling plate disassembling instrument of claim 11, wherein a thickness of the mounting portion is larger than a thickness of each of the two supporting portions to enhance an assembling strength of the mounting portion and the handle.

13. A baffling plate disassembling instrument comprising:
a handle;
a bracket mounted on a top end of the handle, the bracket comprising two supporting portions;
two engaging members, each of the two engaging members mounted on each of the two supporting portions of the bracket, and each of the two engaging members is configured to be inserted into the baffling plate; and
two bumpers, each of the two bumpers surrounding each of the two supporting portions of the bracket.

14. The baffling plate disassembling instrument of claim 13, wherein each of the two bumpers is elastic.

15. The baffling plate disassembling instrument of claim 13, wherein each of the two supporting portions is an elongated plate, two flanges extending upwardly from opposite sides of each of the two supporting portions and sandwich each of the two engaging members therebetween.

16. The baffling plate disassembling instrument of claim 15, wherein each of the two bumpers comprises a base plate arranged on a bottom surface of the supporting portion, and two sidewalls extending from opposite sides of each of the two bumpers and arranged on outer surfaces of the two flanges.

17. The baffling plate disassembling instrument of claim 13, wherein the bracket further comprises a mounting portion located between the two supporting portions and interconnects with the two supporting portions; the bracket is fixed on to the handle by a screw extending through the mounting portion and engaging with the handle; and the two bumpers abut opposite ends of the mounting portion.

18. The baffling plate disassembling instrument of claim 17, wherein each of the two engaging members comprises a engaging portion mounted on the supporting portion, and a crowbar extending from the engaging portion.

19. The baffling plate disassembling instrument of claim 18, wherein the crowbar is a cuneal plate and a thickness of the crowbar is decreased from bottom to top of the crowbar.
